(19) United States
(12) Patent Application Publication
(10) Pub. No.: US 2022/0277113 A1
(43) Pub. Date: Sep. 1, 2022

(54) Computer-implemented method for changing a model geometry of an object

(71) Applicant: Volume Graphics GmbH, Heidelberg (DE)

(72) Inventors: Gerd SCHWADERER, Heidelberg (DE); Johannes FIERES, Heidelberg (DE); Markus RHEIN, Heidelberg (DE)

(21) Appl. No.: 17/634,931

(22) PCT Filed: Aug. 3, 2020
(86) PCT No.: PCT/EP2020/071798

§ 371 Date: Feb. 11, 2022

(30) Foreign Application Priority Data
Aug. 13, 2019 (DE) 10 2019 121 806.3

(51) Int. Cl. G06F 30/17; G06F 30/23

(52) U.S. Cl. CPC G06F 30/17; G06F 30/23; G06F 2113/22

(57) ABSTRACT

The invention relates to changing a model geometry of an object by providing a target geometry and a model geometry for the object; using the model geometry to provide an actual geometry of the object; determining whether there is a deviation between the target geometry and the actual geometry; and changing the model geometry into a modified model geometry on the basis of the determined deviation; wherein determining results in a first non-rigid mapping, if there is a deviation, that associates two geometries with each other by using a parameter set and describing the determined at deviation, or at least the changing is carried out by a second non-rigid mapping that associates two geometries with each other by using a parameter set. Thus, correct values are provided in the event of deviations and deformation, and the corrected values reduce the effort in finding a model geometry for producing an object.

The invention relates to a computer-implemented method for modifying a model geometry of an object.

In the manufacture of components, in particular in casting or additive manufacturing methods, different geometric deviations from the target geometry of the component occur, which can result, for example, from expansion/shrinkage processes and/or material displacements. Therefore, before a component can be manufactured, optimization procedures for the model geometry are first performed so that the subsequently manufactured components match the target geometry within the tolerances.

In a known method for minimizing these deviations, a model geometry is first used to produce a prototype, which is then examined or measured with regard to the deviations. After this, an attempt is made to take account of these deviations or correct them in a modified model geometry during manufacture, in such a way that the deviations no longer occur when other prototypes are manufactured. These steps are repeated until the manufacture of the component is possible, in which deviations outside a defined tolerance no longer occur. This process requires a high level of effort and is costly.

Furthermore, in order to provide a correction to a first approximation, it is known from EP 2 313 867 B1 to reflect the acquired 3D-points of a 3D-point cloud at the surface of the original molding tool as defined by the surface model or, if applicable, by the modified surface model, according to their determined deviation from a corresponding point of a target surface according to the CAD model. To do this, search beams are used to produce the correction vectors and the mapping between the surface points in the CAD model of the component and the surface model of the original molding tool. However, there is as yet no means of producing a mapping and correction that delivers correct values in the case of major deviations or deformations.

The object of the invention can therefore be considered as being to provide a computer-implemented method that provides correct values in the event of deviations and deformations and reduces the effort involved in finding a model geometry for producing an object.

The main features of the invention are specified in claim 1 and claim 15. Embodiments of the invention are the subject matter of claims 2 to 14.

One aspect of the invention relates to a computer-implemented method for modifying a model geometry of an object, wherein the model geometry can be used to produce the object and the method comprises the following steps of: providing a target geometry for the object; providing a model geometry for the object; using the model geometry to provide an actual geometry of the object; determining whether at least one deviation is present between the target geometry and the actual geometry; and changing the model geometry into a modified model geometry based on the determined at least one deviation, if at least one deviation is present; wherein at least the step of determining, if at least one deviation is present, results in a first non-rigid mapping, the first non-rigid mapping associating two geometries with each other by means of a parameter set and describing the determined at least one deviation, or at least the step of changing is carried out by means of a second non-rigid mapping, the second non-rigid mapping associating two geometries to each other by means of a parameter set.

The core of the invention is, in order to produce the association between the corresponding regions, in the steps of determining whether there is at least one deviation present between the target geometry and the actual geometry and/or of changing the model geometry into a modified model geometry based on the determined at least one deviation, if there is at least one deviation, to use not only local information but also more extensive or global information in at least one of the two steps. Using the first and/or second non-rigid mapping, global information is used, wherein, for example, a mapping can be sought which can transform the entire surfaces of the two geometries involved in the respective non-rigid mapping into one another in the best possible manner, wherein the determination of the first non-rigid mapping involves the target geometry and the actual geometry, and the determination of the second non-rigid mapping involves the model geometry and/or the modified model geometry. The first and/or second non-rigid mapping can be a non-rigid registration. Even in the case of major deviations this approach makes it possible to determine a correct association between the geometry regions. Using the first and/or second non-rigid mapping in the steps of determining and/or changing, the deviations between the target geometry and the actual geometry or the corrections between the model geometry and the modified model geometry are adjusted by means of global information about the object. The global information is represented by a parameter set. For example, the number of parameters in the parameter set can be less than the number of points of one of the geometries involved in the non-rigid mapping. The aim is to find a mapping that can transform the entire surfaces of the two geometries into one another as accurately as possible. Even in the case of major deviations, this allows a correct association between the geometry regions of two geometries to be determined. In addition, the first and second non-rigid mappings each define an entire mapping from one geometry to the other. This avoids an inaccurate association between the geometries for each surface point.

With the non-rigid mappings, an association or correction can be calculated for any point, since this information is implicitly contained in the non-rigid mapping. Furthermore, the first or second non-rigid mapping can only be determined on the basis of individual corresponding points in the two geometries and interpolated by means of the mapping or the deviation field between them. In this way, an assignment is also possible in regions in which no corresponding geometries could be identified, such as in the case of major deviations. This may result in more accurate analysis of the deviations between the target and actual geometry or more accurate adjustments of the model geometry to the modified model geometry. This reduces the number of prototypes that need to be produced or simulations to be performed. The invention thus provides a computer-implemented method that reduces the effort involved in finding a model geometry for producing an object.

The computer-implemented method is first used to provide a target geometry for the object. The target geometry represents the state of the object that is to be achieved after production. In addition, in a further step the computer-implemented method provides a model geometry for the object, the model geometry then being used to produce the object. For example, the model geometry can deviate from the target geometry and take into account already known changes that occur during the manufacturing process of the object. Alternatively, the model geometry can comprise the target geometry and only be modified according to the method. The model geometry is then used to provide an actual geometry of the object. Either an object can be produced using the model geometry or an object can be simulated using a simulation program. In both cases, the result is an actual geometry of the object.

The actual geometry therefore does not necessarily need to be based on a physical object, but can also be based on a virtual object. The target geometry and the actual geometry are then compared against each other and deviations are determined. In this step, a first non-rigid mapping can be used to determine the at least one deviation. In the next step the model geometry is then changed to a modified model geometry, with the modified model geometry taking into account the at least one determined deviation. In this step, a second non-rigid mapping can be used to determine the at least one deviation. In one example, the determined at least one deviations between the target geometry and the actual geometry can be transferred directly to the other side when modifying the model geometry to form the modified model geometry. That is, at the location of the deviation between the target geometry and the actual geometry the modified model geometry would have a change reflected at an imaginary surface of the target geometry. This would therefore correspond to a correction with a factor of 1 or a translation with a factor of −1. Alternatively, larger-sized factors can be selected if, based on experience, the correction turns out to be too small, or smaller-sized factors can be selected if over-adjustments are found to occur or in order to avoid instabilities in the iterative procedure. Such a factor can be easily implemented in a non-rigid mapping, for example by multiplying the corresponding mapping vectors by the factor. If no model geometry is available, corrections can be made directly on the target geometry. Otherwise, the model geometry or modified model geometry is corrected, which requires an association with the actual or target geometry. If necessary, a registration of the coordinate system is carried out in advance for this purpose, but usually the model geometry or the modified model geometry will be in the same coordinate system as the target geometry. In another example, the geometry can still be manually post-processed to enable manufacturing to take place.

According to the invention, a non-rigid mapping is used in at least one of the two steps of determining or changing. If a first non-rigid mapping is not used in the determining step, a conventional method can be used, for example using search beams. If a second non-rigid mapping is not used in the changing step, conventional methods can also be used here.

The target geometry is the desired geometry of the object to be manufactured. This can be defined as a CAD model or by means of a technical drawing. Manufacturing tolerances can also be specified, e.g. using product and manufacturing information (PMI). In additive manufacturing, for example, the geometry can be specified as a mesh in the STL format. Other descriptions, including mathematical ones, are also conceivable.

The actual geometry is the measured geometry of the manufactured object. The actual geometry can exist in various formats or representations, e.g. as volume data from a CT scan, as a point cloud, as a surface file, e.g. STL, as an implicitly defined surface based on a distance field, as individual measuring points or measuring lines, measured e.g. by tactile sensors, as a representation using regular geometry elements or mathematically defined surfaces such as non-uniform rational B-splines, so-called NURBS. Furthermore, the actual geometry can be derived from a simulation of the manufacturing process and thus be obtained completely without measurement. In this way, a correction of this simulated manufacturing can be carried out.

The model geometry can be the geometry used to produce the object, for example, using the tool. The model geometry thus determines the shape of the object on which the tool is based when manufacturing the object. For example, the object can be produced using a casting mold, a punching die, or an additive manufacturing device. A simulation program can use the model geometry to create a virtual object. The model geometry is a variation based on the target geometry which is used to manufacture the object. The aim is to allow the model geometry to take into account deviations that occur in the manufacturing process, in such a way that the manufactured component corresponds as closely as possible to the target geometry.

The modified model geometry is derived from the method according to this invention after the method has been carried out at least once. If the method is repeated more than once, the model geometry modified in the previous repetition is used as the model geometry in the next repetition to provide the actual geometry. However, modifications can be introduced before the method is carried out, for example on the basis of simulations of the casting process or the experience of the user, in order to approximate the target geometry as closely as possible in the first iteration run. Because this modified geometry is used to manufacture the object, in certain manufacturing methods, for example, the prototype process or the molding process, this geometry can also describe the tool used to manufacture the object, e.g. the mold used in an injection molding process. This tool is usually approximately a negative of the target geometry in this case.

Alternatively or additionally, the model geometry can be identical to the target geometry. This is not mandatory, however. The object can be a prototype that was produced using the model geometry. Furthermore, the object can be a component that has been manufactured using the model geometry by a tool in use, and therefore it may have manufacturing deviations. An object can therefore also be extracted from an ongoing manufacturing process.

In all cases, the geometry is essentially defined by a surface of the object.

A non-rigid mapping is a mathematical transformation which assigns coordinates from one space to corresponding coordinates from another space. In contrast to a rigid mapping, which only comprises translations and rotations and thus has six degrees of freedom, a non-rigid mapping can also take into account deformations, both on global and local orders of magnitude. The number of degrees of freedom here is significantly greater than in rigid mappings and is limited in practice by the resolution of the mapping.

To calculate a non-rigid mapping, two steps are necessary: first, a mathematical model which describes the mapping is provided. This model has a certain parameter set which must be determined. In addition, a suitable mapping is determined for the particular case and thus the parameter set of the mathematical model found is the one which enables the optimal assignment of the geometries under consideration.

In the case of the non-rigid mappings according to the invention, the image space and the value space are not limited to one manifold, e.g. the surface. Instead, the mapping is also defined or computable at least for a region around the surface, or even the entire volume.

Furthermore, a non-rigid mapping is usually at least piecewise continuous, i.e. the mapping of two directly adjacent points does not make any major jumps.

Non-rigid mappings represent features of an object that logically correspond to each other in the different geometries. This means that the topology or the neighborhoods are taken into account in determining the mapping. Therefore, the non-rigid mapping can also be used as a registration.

Furthermore, the model geometry provided can be, for example, a modified target geometry.

The modified target geometry can be, in particular, the geometry of a tool or else a modified model geometry based on a corrected target geometry. In an intermediate step, expected deviations can be compensated in order to achieve a result as close as possible to the nominal geometry in the first manufacturing process. In addition, in some manufacturing processes it is necessary to determine the geometry of a tool using the nominal geometry, which can also be interpreted here as a modified target geometry.

The method can also comprise the following step: repeating the steps of using, determining and changing as long as the determined at least one deviation is outside a predefined tolerance range for the determined at least one deviation.

The repetition takes place until there are no longer significant deviations between the actual geometry of the object, produced using the modified model geometry, and the target geometry. The significance of the deviations can be defined by predefined tolerance ranges, where the tolerance ranges can be defined locally.

The at least one deviation can be assigned to a region of the model geometry, wherein the step of changing is only carried out for the region if the at least one deviation is outside a predefined tolerance range for the determined at least one deviation.

In this case, the correction can be applied to a gradually weaker amount in the transition region from regions to be corrected to regions not to be corrected, in order to avoid discontinuities. To this end, the strength or factor with which the correction is performed can gradually decrease to 0 beyond the regions to be corrected.

For example, the changing step can also comprise the following sub-step: transferring the determined at least one deviation to the model geometry by means of the second non-rigid mapping, the second non-rigid mapping having an association between the target geometry and the model geometry and/or between the actual geometry and the model geometry.

The deviation can be transferred to the model geometry during the mapping from the target geometry to the model geometry, or during the mapping between the actual geometry and the model geometry, in order to obtain a modified model geometry. Alternatively, the deviation can also be transferred before or after each one.

Furthermore, the second non-rigid mapping can map the model geometry to the target geometry and/or the model geometry to the actual geometry.

When mapping the model geometry to the target geometry, the deviation can be corrected in the target geometry first and then transferred to the model geometry, for example by applying a reverse mapping to the second non-rigid mapping, to obtain the modified model geometry. When mapping the model geometry to the actual geometry, the deviation can be corrected in the actual geometry, for example, in order then to obtain the modified model geometry by means of a reverse mapping.

In another example, the changing step may comprise the following sub-step: changing the model geometry to the modified model geometry using the first non-rigid mapping.

In this example, the combination of the second non-rigid mapping, which represents a mapping between the model geometry and the actual geometry or the target geometry, and the first non-rigid mapping, which describes the at least one deviation between the target and the actual geometry, can be used to obtain the modified model geometry. For example, an inverse mapping of the first non-rigid mapping can be used to compensate for the deviation in the model geometry.

Before the step of determining whether at least one deviation is present between the target geometry and the actual geometry, the method can also comprise the following steps: determining a rigid mapping between the actual geometry and the target geometry to register the actual geometry and the target geometry, wherein the rigid mapping takes into account predefined local tolerance ranges for different regions of the target geometry and minimizes deviations between the actual geometry and the target geometry outside the local tolerance ranges.

The rigid mapping for registering the actual geometry and the target geometry can be carried out to achieve a first, coarse association between the actual geometry and the target geometry. From this starting point, the first, possibly non-rigid, mapping can be determined faster or more accurately. In regions with a large tolerance, for example, larger deviations may be permitted since no correction is required here anyway. Instead, the alignment can be optimized with respect to the important regions of low tolerance. This can minimize the number of regions to be corrected.

In another example, the step of using the model geometry to provide an actual geometry of the object can advantageously also comprise the following sub-step: providing the actual geometry from measurement data of a computer tomographic measurement of the object.

In this case, the entire geometry of the object is known. This facilitates the determination of a non-rigid mapping.

For example, the changing step can comprise the following sub-steps: providing at least one sub-region of the model geometry, the at least one sub-region being associated with the determined at least one deviation; and changing the at least one sub-region with the determined at least one deviation into at least one modified sub-region; providing the at least one sub-region for modifying the model geometry.

Therefore, only the regions of the model geometry that have at least one deviation are modified. These sub-regions are changed in a modified sub-region where the deviation is to be corrected. With the computer-implemented method, the required computing power is thereby reduced, since it is not the entire model geometry that is changed but only the individual points of the sub-regions with the deviations. In order to reduce the complexity of the automated editing or correction of an entire CAD model, for example, only individual patches, i.e. regions of the CAD model, can be edited. On this basis, the entire model geometry can be edited.

The sub-region can be a regular geometry element, for example, a plane or a cylinder. This means that the deviation is arranged within the regular geometry element, for example the plane or the cylinder.

In another example, the step of changing can comprise the following sub-step: changing the model geometry into a modified model geometry based on the determined at least one deviation, taking into account local modifications resulting from the determined at least one deviation, using the second non-rigid mapping.

In an example, the first non-rigid mapping can be applied for the modification. The modification can be carried out by means of a rotation, a scaling and/or a shear. Using the first non-rigid mapping, a local modification can be carried out by means of a rotation, scaling and/or shear.

Furthermore, the first non-rigid mapping and/or the second non-rigid mapping can be defined by means of control points.

The control points can be evenly distributed over the space that contains the object. Alternatively, the control points can be defined only on the object. In addition, the control points can have a density which is greater in at least one predefined region of the object than outside the at least one predefined region, wherein the predefined region comprises an environment of a surface of the object and/or an environment around the determined at least one deviation if the determined at least one deviation exceeds a predefined threshold value, and/or comprises an environment around the determined at least one deviation if the determined at least one deviation has a gradient above a predefined gradient threshold value.

Furthermore, the first non-rigid mapping can only change a topology of the model geometry within a predefined modification range.

The first non-rigid mapping thus changes the topology of the model geometry only within predefined limits. This avoids major changes, thereby reducing large variations in the model geometry during an iteration process. This facilitates the model's convergence to a modified model geometry that corresponds to the target geometry. In this context, the term topology also includes the representation of the surface. Examples of this are the connectivity of a surface stored in the STL format and the connectivity of the control points of a free-form surface defined by NURBS.

A further aspect of the invention relates to a computer program product having instructions executable on a computer, which when executed on a computer cause the computer to carry out the method as claimed in the preceding description.

Advantages and effects as well as extensions of the computer program product arise from the advantages and effects as well as the extensions of the above described method. In this respect, reference is therefore made to the preceding description.

For example, a computer program product can mean a data carrier on which a computer program element is stored, that contains instructions that can be executed for a computer. Alternatively, or in addition, a computer program can also mean, for example, a permanent or volatile data store, such as flash memory or memory, that contains the computer program element. However, other types of data stores that contain the computer program element are not excluded.

Further features, details and advantages of the invention result from the wording of the claims, as well as from the following description of embodiments on the basis of the drawings. In the drawings:

FIG. 1 shows a flowchart of the computer-implemented method for modifying a model geometry of the object;

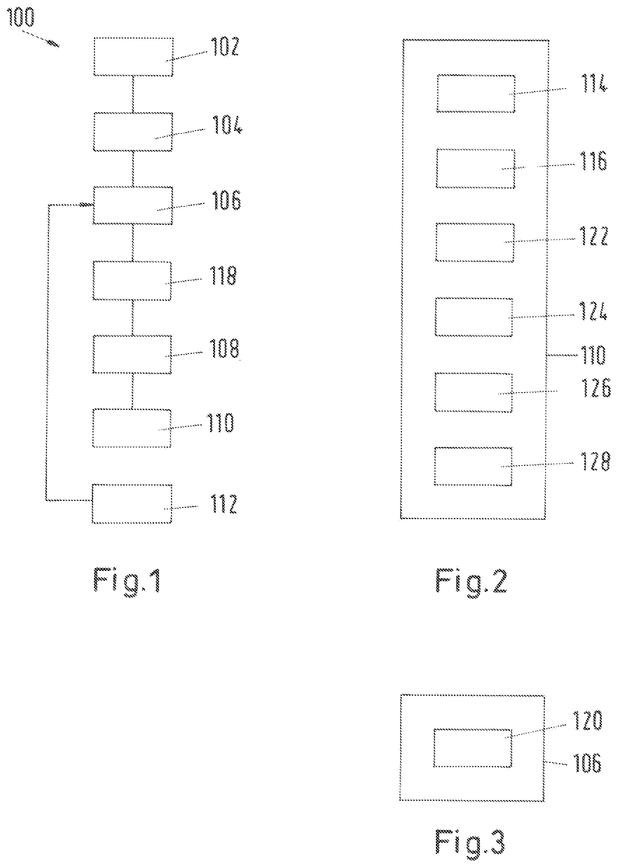

FIG. 2 shows a diagram of an embodiment of a step of the method;

FIG. 3 shows a diagram of an embodiment of a step of the method;

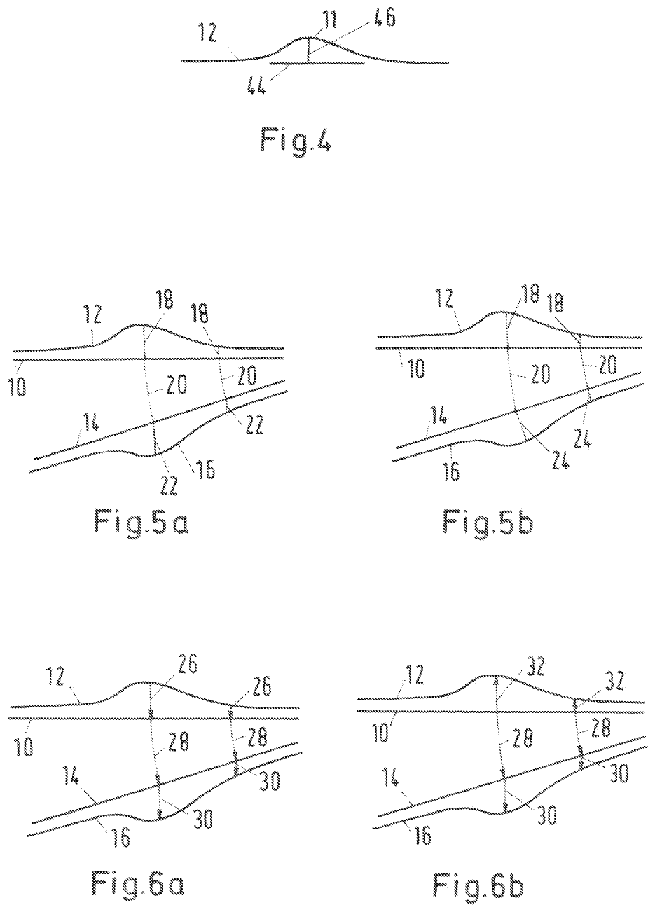

FIG. 4 shows a schematic illustration of a deviation on an actual geometry;

FIG. 5a, b shows a schematic illustration of the different geometries and their relationship to each other;

FIG. 6a, b shows a schematic illustration of different definitions of a mapping between the geometries;

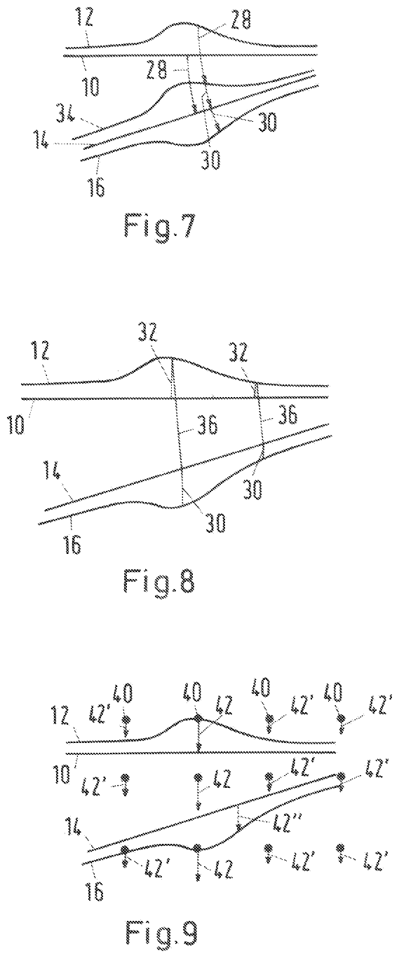

FIG. 7 shows a schematic illustration of two exemplary procedures for obtaining a modified model geometry;

FIG. 8 shows a schematic illustration of further embodiments of the method; and

FIG. 9 shows a schematic illustration of an embodiment with a non-rigid mapping in the form of a field.

The following explains in more detail the computer-implemented method 100 for modifying a model geometry of the object by reference to FIG. 1.

In a first step 102, a target geometry for the object is provided. This can be a so-called nominal geometry, which is used to define the desired geometry of the object. The target geometry can be provided as a CAD model, for example.

In a further step 104, a model geometry for the object is provided. The model geometry can be used to produce the object. The model geometry provided can be a modified target geometry that takes into account existing known deformations during the production of the object that can lead to a deviation between the actual geometry and the target geometry.

In a further step 106, the model geometry can be used as the geometry of an original mold for a casting process or an injection molding process in order to produce an object and thus obtain an actual geometry. Alternatively or additionally, the model geometry can be used for an additive manufacturing process. Furthermore, the model geometry can alternatively or additionally be used by a simulation program to calculate an actual geometry of an object.

Then, in step 118, a rigid mapping between the actual geometry and the target geometry can be determined. The rigid mapping can be used to register the actual geometry and the target geometry. The rigid mapping takes into account predefined local tolerance ranges for different regions of the target geometry. The local tolerance ranges are tolerance ranges that are defined locally on the geometry of the object. For example, a region on the object that does not interact with other elements or components can have a large tolerance range. By contrast, regions of the object that interact with other elements or components have small tolerance ranges, because these must be manufactured more accurately. Furthermore, the rigid mapping can minimize deviations between the actual geometry and the target geometry outside the local tolerance ranges.

Then, in a further step 108, it is determined whether at least one deviation is present between the target geometry and the actual geometry. To do this, the target geometry is compared with the actual geometry. This can be achieved with a first non-rigid mapping. The first non-rigid mapping can have a parameter set that enables the non-rigid mapping to map the target geometry and the actual geometry to each other over the entire coordinate system. The first non-rigid mapping thus also describes the at least one deviation between the actual geometry and the target geometry.

For step 108, in a first exemplary embodiment a first non-rigid mapping between the actual geometry and the target geometry can be determined. In another exemplary embodiment, in step 108, methods are used to determine the local deviation which do not include a non-rigid mapping.

In step 110, the model geometry is modified using the at least one deviation determined in step 108. If no deviation is present, in step 110 the method is terminated. If a deviation is present, in step 110 a second non-rigid mapping can be used to provide a modified model geometry from the model geometry. The second non-rigid mapping has a set of parameters for this purpose, which enables the second non-rigid mapping to associate the model geometry and the modified model geometry to each other. The second non-rigid mapping describes a change between the model geometry and the modified model geometry, wherein the change corrects the at least one deviation between the actual geometry and the target geometry. The aim is for an actual geometry of an object produced using the modified model geometry to have fewer deviations from the target geometry than the actual geometry of the object produced using the model geometry.

Thus, in a first exemplary embodiment of step 110, a second non-rigid mapping between the target geometry and the model geometry can be determined. In a second exemplary embodiment of step 110, a second non-rigid mapping between the actual geometry and the model geometry is determined. In another exemplary embodiment of step 110, the transfer of the deviation can be performed by directly determining a possibly local correction value for the previous model geometry based on step 108. In a further exemplary embodiment, methods are used for determining the association between the target geometry or the actual geometry and the modified model geometry which do not comprise a non-rigid mapping.

The combination in which both steps 108 and 110 do not use a non-rigid mapping is not the subject matter of the invention. That is, according to the invention, at least the first non-rigid mapping is used in step 108 or at least the second non-rigid mapping is used in step 110. Furthermore, the first non-rigid mapping and the second non-rigid mapping can also be used simultaneously.

At least the steps 106, 108 and 110 can be repeated in a step 112. The repetition is carried out until the at least one deviation determined during a repetition is within a predefined tolerance range for the determined at least one deviation. This means that the deviations of the actual geometry of the object, produced on the basis of the modified model geometry, from the target geometry correspond to the target geometry within the tolerances.

The at least one deviation can be associated with a region of the model geometry, wherein the model geometry can be divided up into different regions. During step 110, only the region of the model geometry that has the at least one deviation is changed to obtain the modified model geometry. The regions that contain no deviation are not changed to arrive at the modified model geometry. Furthermore, the tolerance ranges for the different regions are mainly used to correct regions where the tolerance ranges are small Regions with large tolerance ranges are only corrected if the deviations are large. Small deviations lying within the tolerance ranges can be tolerated in these regions.

Step 110 can comprise additional sub-steps. These are shown together in FIG. 2 and are optional in each case and can be combined with each other. The modification step may comprise sub-step 114, in which the determined at least one deviation is/are transferred to the model geometry by means of the second non-rigid mapping. The second non-rigid mapping comprises an association between the target geometry and the model geometry in a first alternative. This means that the second non-rigid mapping can map the target geometry to the model geometry or vice versa. In another alternative, the second non-rigid mapping comprises an association between the actual geometry and the model geometry. This means that the second non-rigid mapping can map the actual geometry to the target geometry or vice versa. In both cases, the second non-rigid mapping uses the model geometry.

In addition, step 110 can comprise sub-step 118, in which a rigid mapping is obtained between the actual geometry and the target geometry. This rigid mapping can be used to register the actual geometry and the target geometry. During registration, predefined local tolerance ranges for different regions of the target geometry are taken into account by the rigid mapping. Furthermore, deviations between the actual geometry and the target geometry outside the local tolerance ranges are minimized

In another sub-step, the step 110 can comprise steps 122, 124, and 126. In sub-step 122, at least one sub-region of the model geometry is provided which is assigned to the at least one deviation. This means that a sub-region of the model geometry around the deviation is determined and provided only after determining the at least one deviation. This at least one sub-region is modified in step 124 with the determined at least one deviation. This corrects the determined deviation in the sub-region. The sub-region is provided in step 126 in order that a model geometry can be modified, resulting in a modified model geometry.

Another sub-step 128 of step 110 relates to the changing of the model geometry into a modified model geometry. Step 128 is carried out on the basis of the determined at least one deviation and taking into account local modifications. The local modifications result from the determined at least one deviation, where the deviation results from local deformations of the object, for example. The local modification is taken into account by using the second non-rigid mapping. The second non-rigid mapping corrects the local modifications and the deviation itself in the modified model geometry. The correction of the local modifications can be carried out by means of a rotation, a scaling and/or a shear.

According to FIG. 3, step 106, which uses the model geometry to provide an actual geometry of the object, can comprise the sub-step 120. In step 120, the actual geometry is provided from measurement data of a computer tomographic measurement of the object. For this purpose, the object produced by means of the model geometry is measured by means of a computer tomograph. The actual geometry of the object is determined from the measurement data. In another alternative or additional case, the model geometry can be used to produce an object in a subtractive manufacturing process, e.g. CNC milling. In this case the geometry that is used for programming the CNC milling tool is corrected.

Alternatively or in addition, optical sensors can also provide high-resolution information relating to the external surface. In addition, tactile sensors can record individual measuring points of the surface.

FIG. 4 shows a schematic illustration of a deviation on an actual geometry 12 of an object. The deviation in FIG. 4 and the following figures is exaggerated to allow the procedure to be visualized better. In practice, the distance 46 and the difference between target geometry 10 and model geometry 14 are usually significantly smaller than the dimension 44. Thus, large-area deviations with comparatively low edge angles are corrected.

FIGS. 5a and 5b show in a schematic illustration how the actual geometry 12, the target geometry 10, the model geometry 14 and the modified model geometry 16 can in principle be related to one another. In all the exemplary embodiments described below it is possible in principle for the correction to be applied at the new location in the original orientation or direction according to FIG. 5a, or for the orientation or direction of the correction to be changed or rotated according to FIG. 5b.

The at least one deviation 18 between the actual geometry 12 and the target geometry 10 can be described by means of the first non-rigid mapping. FIG. 5a also shows the transition 20 between the target geometry 10 and the model geometry 14 which was used for producing the object on which the actual geometry 12 is based. In this example, the correction or modification 22 of the model geometry 14 into the modified model geometry 16 is oriented in the same direction as the deviation 18.

According to FIG. 5b, the at least one deviation 18 between the actual geometry 12 and the target geometry 10 is converted into a correction or modification 24 between the model geometry 14 and the modified model geometry 16, which takes into account a change of direction included within the transition 20 between the target geometry 10 and the model geometry 14. In contrast to the modification 22 from FIG. 5a, the modification 24 from FIG. 5b shows the same relative orientation between model geometry 14 and the modified model geometry 16 as the at least one deviation relatively between the actual geometry 12 and the target geometry 10. In non-rigid mappings, not only is a point-to-point association possible, but also a local modification such as a local change of direction can be determined implicitly or explicitly.

FIGS. 6a and 6b illustrate, using the example of the mapping between the actual geometry and the target geometry, that this mapping can be defined differently. A mapping 26 can be defined from the actual geometry 12 to the target geometry 10, as shown in FIG. 6a, or conversely a mapping 32 from the target geometry 10 to the actual geometry 12. Care must be taken to ensure that the respective mapping 26, 32 is used correctly in a subsequent correction so that the change 22, 24 between the model geometry 14 and the modified model geometry 16 corrects the deviation 18 and does not reinforce it. In some cases it may be necessary to use the inverse of the mappings 26, 32 to obtain a correct modification 22, 24. For example, the mapping 32 of FIG. 6b must first be inverted to obtain a correct mapping 30 to convert between the model geometry 14 and the modified model geometry 16. The mapping 26 of FIG. 6a can be used without inversion as the mapping 30 to convert between the model geometry 14 and the modified model geometry 16.

The same applies to the mapping 28 between the target geometry 10 and the model geometry 14 and all other mappings.

In another example, the modified model geometry 16 can be obtained from the actual geometry 12 by double application of the mapping 26 or the inverted mapping 32 and single application of the mapping 28. The second application of the mapping 26 or the inverted mapping 32 corresponds to the application of mapping 30.

In a preferred example, starting from the model geometry, the single application of the mapping 26 or the inverted mapping 32 as mapping 30 may suffice, wherein the mapping 28 allows the identification of the associated mapping 26 or the inverted mapping 32 for each individual point.

According to another example, starting from the target geometry 10, by a single application of the mapping 26 or the inverted mapping 32 as mapping 30, the same target can be achieved as with a single application of mapping 28, as shown in FIG. 7.

FIG. 7 shows two exemplary procedures. Also according to FIG. 7, the actual geometry 12 can also be first transformed to a different model geometry 34 using the mapping 28. In this case, any deviation that the actual geometry 12 has from the target geometry 10 will be maintained after the mapping with respect to the model geometry 14. The deviating model geometry 34 can then be corrected immediately by means of the mapping 30, which results from the mapping 26 or the inverted mapping 32.

In addition to the rotation, local scaling and shearing operations can also be defined by the non-rigid mappings or, more precisely, by the respective derivatives of the non-rigid mappings. These are not shown here, but can also be taken into account when applying the correction.

FIG. 8 shows the case in which in principle the assignment from the actual geometry 12 to the model geometry 14 by means of a mapping 36 is used. As was the case in FIG. 4, multiple exemplary embodiments are also possible here.

In one example, starting with the actual geometry 12, this can be transformed into the modified model geometry by a single application of mapping 36 and a single application of mapping 30, which results from the mapping 26 or inverted mapping 32.

In another example, starting from the model geometry 14 the single application of mapping 30 can suffice, wherein the mapping 36 allows the identification of the associated mapping 26 or inverted mapping 32 for each individual point.

FIG. 9 shows a field with arrows which represent a correction vector for each point, calculated from it. In this implementation of a non-rigid mapping, a value for the mapping can be determined or interpolated/extrapolated for any chosen coordinates.

Here it is advantageous if the size of the distance 46 or necessary correction is significantly smaller than the lateral extent 44 of the distance 46 to be corrected. The use of a field can be further advantageous if the distance between the model geometry and the target geometry is comparatively small, so that the field of the mapping 26 barely changes over this distance. To determine the underlying models of the non-rigid mappings, control points or support points can be defined and the deformation or mapping between these can be interpolated or extrapolated.

In this example, the second non-rigid mapping is not needed because the first non-rigid mapping is applied at the position of the model geometry. Assuming that the distance from the model geometry to the target or actual geometry is small compared to the change in the first non-rigid mapping over the space, the desired result is obtained to a good approximation as a modified model geometry.

The control points can be in a regular or an irregular grid. For example, the irregular grid may have a higher resolution in important regions, such as in the vicinity of the surface, in regions with large deformation or in regions where the mapping does not achieve a good approximation to the target geometry. This reduces the total number of control points and thus reduces the computing time required. Even if the resolution of the control points is variable, a regular grid can be maintained in principle.

In addition, a normal rigid adjustment can be determined in some sections and, if necessary, interpolation can be used between them.

In a further example, the possibly location-dependent mapping can be described globally and thus analytically for the entire three-dimensional space under consideration, e.g. with the aid of a Fourier series.

A regularization of the mapping can also be carried out in order to counteract strong outliers in the data, geometries or deformations.

An error measure and an optimizer can be used to determine the non-rigid mapping.

The error measure describes how closely the geometries to be mapped onto each other match after the application of the mapping. Corresponding features in both geometries can be used for this purpose, for example the surfaces, edges, corners, easily recognizable geometries, so-called landmarks, geometries or geometry regions defined by the evaluation map, or manually defined geometries or landmarks. The corresponding features in the geometries can also be identified by an artificial intelligence tool. The Hausdorff metric provides one way of calculating the error measure.

If the aim is to achieve the best possible assignment of the surface regions to the geometries under consideration by using the mappings of the method 100, the surface of the geometries in question is preferably analyzed. Using the optimizer, the mathematical model is parameterized to find the best match, which usually means that the error measure is minimized. At the same time, however, boundary conditions may be applied to prevent over-adaptation, which can be referred to as regularization.

While global scaling of the component can allow a good match between the geometries, in some cases it is not realistic. Therefore, a global scaling can be limited or sanctioned.

The optimizer can work from a coarse resolution to a fine resolution. For example, a few support points are used initially to allow a coarse assignment of the corresponding geometries to each other. Gradually, the number of support points is increased to allow consideration of smaller geometries of the object in the mapping as well. This ensures that the mapping converges to the best solution. In an analytical description, a similar procedure can be used, for example, by gradually increasing the number of terms considered in the Fourier series.

In a similar way, it is also possible to manipulate the minimum order of magnitude or maximum local frequency that is sought by means of the mapping to correct deviations in the mapping. This minimum order of magnitude can be interpreted, for example, as the minimum lateral extension of a deviation that can still be corrected. This can be useful, for example, if certain frequency ranges are to be retained as a deviation of the geometry and therefore should not or cannot be corrected.

A cutoff frequency is usually defined for this purpose. This can also prevent direction vectors from being incorrectly mapped due to local over-adjustments. Again, this can be implemented by only using control points or considering the Fourier series up to a corresponding resolution in the model.

Regardless of the approach chosen, it can be useful to perform a rigid registration of the actual geometry and the target geometry before determining the mapping in order to obtain a first, coarse mapping. It is then to be expected that the first or second non-rigid mapping can be determined faster or more accurately from this starting point.

The method described above can be used, as explained above, to correct a model geometry of an object, wherein the model geometry can be used for producing the object. Alternatively or in addition, it is possible to search for a mapping of the target geometry, which can be available as a CAD model, for example, onto the actual geometry. The target geometry existing in the form of a CAD model is then deformed to the actual geometry. The result would be a CAD model which has the actual geometry, but still has the representation or basic geometric structure, e.g. geometry elements or edges of the CAD model.

Furthermore, the correction can be applied in such a way that the topology, e.g. of the surface, the modified geometry, e.g. defined by the structure of a CAD model or the connectivity of the surface elements of a mesh, is retained.

If the correction is carried out iteratively, the association between target geometry and modified model geometry can be stored. Thus, the mapping 28 for the next iteration can be simply determined. The stored modified model geometry can be used as the basis for the corrections.

In addition, in particular in the case of flexible objects with large-scale global deformations and small-scale local deviations which must be corrected, step 108 can be carried out with two sub-steps. In a first sub-step, a low-resolution mapping is determined which compensates for the global deformations. A further high-resolution mapping is then determined, which covers local deviations. This can also be defined in sections. This means that a high-resolution mapping may be determined only in specified regions in which a correction is to be carried out or in which significant deviations have been detected. The deviations can then be mapped with high resolution and thus corrected, although the number of degrees of freedom remains manageable, since high resolution is only used in the relevant regions.

Furthermore, the high-resolution mapping alone may be used for the correction. This process would allow the local deviations to be corrected, while for global deformations, which in some cases are not problematic, no effort would need to be expended to correct them.

Edges and corners of the geometries can be used as landmarks to determine the mapping. Furthermore, defects inside the real geometry or measurement data can be ignored during the determination, as these do not occur in the nominal geometry.

Furthermore, it is possible to define, for example by means of an evaluation map, the CAD model or by user input, the regions in which any correction should be carried out at all. No correction is then made in the remaining regions. The correction can then be carried out only in regions in which the deviation is determined above a defined tolerance and a large tolerance is then selected in the corresponding regions.

In order to avoid discontinuities from the boundary between the regions in which a correction is performed and no correction is performed, the strength or factor with which the correction is performed can slowly decrease to 0 beyond the regions to be corrected.

Furthermore, the alignment of the actual geometry to the target geometry can be carried out in such a way that the deviations are minimized, in particular in the relevant regions, which can be, for example, the regions with low tolerance. This minimizes the corrections to be made.

Furthermore, the resolution of the mappings 28, 26 or 32, and 30 can be varied, for example, determined by the density of the control points, based on the local deviation between the actual geometry and target geometry. In the regions with greater deviation, the resolution is then higher, as a better modeling of the correction might be necessary here. Although the resolution is only determined by the deviation between the mappings 26 and 32, the resolution is also transferred to mapping 28.

The procedure can also allow a user the facility to edit the non-rigid mapping manually, for example, by moving control points of the mapping or the correction.

The invention is not restricted to any one of the embodiments described above but may be modified in a wide variety of ways.

All of the specified features and advantages resulting from the claims, the description and the drawing, including constructional details, spatial arrangements and method steps, can be essential to the invention either in themselves or in the most diverse of combinations.

### LIST OF REFERENCE SIGNS

10 target geometry
12 actual geometry
14 model geometry
16 modified model geometry
18 deviation
20 transition
22 modification
24 modification
26 mapping
28 mapping
30 mapping
32 mapping
34 deviating model geometry
36 mapping

1. A computer-implemented method for modifying a model geometry of an object, wherein the model geometry can be used to produce the object, the method comprising the following steps:
providing a target geometry for the object;
providing a model geometry for the object;
using the model geometry to provide an actual geometry of the object;
determining whether there is at least one deviation present between the target geometry and the actual geometry; and
changing the model geometry into a modified model geometry based on the determined at least one deviation, if at least one deviation is present;
wherein at least the step of determining, if at least one deviation is present, results in a first non-rigid mapping, the first non-rigid mapping associating two geometries with each other by means of a parameter set and describing the determined at least one deviation, or at least the step of changing is carried out by means of a second non-rigid mapping, the second non-rigid mapping associating two geometries to each other by means of a parameter set.

2. The method as claimed in claim 1, wherein the provided model geometry is a modified target geometry.

3. The method as claimed in claim 1, wherein the method also comprises the following step:
repeating at least the steps of using, determining and changing as long as the determined at least one deviation is outside a predefined tolerance range for the determined at least one deviation.

4. The method as claimed in claim 1, wherein the at least one deviation is assigned to a region of the model geometry, wherein the step of changing is only carried out for the region if the at least one deviation is outside a predefined tolerance range for the determined at least one deviation.

5. The method as claimed in claim 1, wherein the step of changing also comprises the following sub-step:
transferring the determined at least one deviation to the model geometry by means of the second non-rigid mapping, the second non-rigid mapping having an association between the target geometry and the model geometry and between the actual geometry and the model geometry.

6. The method as claimed in claim 5, wherein the second non-rigid mapping maps the model geometry to the target geometry and the model geometry to the actual geometry.

7. The method as claimed in claim 1, wherein the step of changing also comprises the following sub-step:
changing the model geometry to the modified model geometry using the first non-rigid mapping.

8. The method as claimed in claim 1, wherein the method also comprises, before the step of determining whether at least one deviation is present between the target geometry and the actual geometry, the following step:
determining a rigid mapping between the actual geometry and the target geometry to register the actual geometry and the target geometry, wherein the rigid mapping takes into account predefined local tolerance ranges for different regions of the target geometry and minimizes deviations between the actual geometry and the target geometry outside the local tolerance ranges.

9. The method as claimed in claim 1, wherein the step of using the model geometry to provide an actual geometry of the object further comprises the following sub-step:
providing the actual geometry from measurement data of a computer tomographic measurement of the object.

10. The method as claimed in claim 1, wherein the step of changing further comprises the following sub-steps:
providing at least one sub-region of the model geometry, with the at least one sub-region being associated with the determined at least one deviation;
changing the at least one sub-region with the determined at least one deviation into at least one modified sub-region; and
providing the at least one sub-region to modify the model geometry.

11. The method as claimed in claim 1, wherein the step of changing further comprises the following sub-step:
changing the model geometry into a modified model geometry based on the determined at least one deviation, taking into account local modifications resulting from the determined at least one deviation, using the second non-rigid mapping.

12. The method as claimed in claim 1, wherein the first non-rigid mapping and/or the second non-rigid mapping are defined by means of control points.

13. The method as claimed in claim 12, wherein the control points have a density which is greater in at least one predefined region of the object than outside the at least one predefined region, wherein the predefined region comprises an environment of a surface of the object and an environment around the determined at least one deviation if the determined at least one deviation exceeds a predefined threshold value, and comprises an environment around the determined at least one deviation if the determined at least one deviation has a gradient above a predefined gradient threshold value.

14. The method as claimed in claim 1, wherein the first non-rigid mapping changes a topology of the model geometry only within a predefined modification range.

15. A computer program product having instructions executable on a computer, which when executed on a computer cause the computer to carry out the method as claimed in claim 1.
